(19) United States
(12) Patent Application Publication
(10) Pub. No.: US 2013/0171326 A1
(43) Pub. Date: Jul. 4, 2013

(54) LOW SODIUM SALT SUBSTITUTE COMPOSITIONS

(71) Applicant: Richard S. Meyer, Kent, WA (US)

(72) Inventor: Richard S. Meyer, Kent, WA (US)

(21) Appl. No.: 13/343,581

(22) Filed: Jan. 4, 2012

(51) Int. Cl. A23L 1/237; A23L 1/307

(52) U.S. Cl. 426/649; 426/531

(57) ABSTRACT

Various low sodium salt substitute compositions are disclosed, as well as food products comprising the same.

### BACKGROUND

1. Technical Field

The present disclosure is directed to low sodium salt substitute compositions, and food products comprising the same.

2. Description of the Related Art

There has been growing concern in recent years about the effect of excessive dietary sodium intake. Excessive sodium intake is believed to be the cause of certain deleterious health problems such as various cardiac and renal conditions. Moreover, the accumulation of sodium ions in the body tends to cause an accumulation of fluids, with a corresponding increase in weight, by the body tissues.

The primary source of sodium in the diet is sodium chloride, namely, salt, which enters the diet via multiple pathways including: (i) food naturally containing sodium chloride; (ii) processed foods to which sodium chloride and other sodium salts are added; and (iii) food to which sodium chloride is added by an individual during cooking or prior to eating. The final two pathways have posed the greatest problem of excessive sodium ion intake in the diet.

Significant attention has been directed to ways to remove sodium chloride from the diet, including removal from processed foods. However, the removal of sodium chloride from the human diet poses certain challenges. In particular, the “salty” taste associated with sodium chloride is a particularly important flavor characteristic in many kinds of foods and foods which do not have a salty taste are often described as “bland” or “tasteless”.

Many attempts have been made to provide salty tasting compositions as a substitute for table salt. To this end, potassium chloride, ammonium chloride and similar compounds have been suggested. However, the use of these chlorides alone or in combination does not provide the desired taste or seasoning effect of sodium chloride. Potassium chloride has a strong aftertaste which is usually characterized as bitter by most people. Ammonium chloride also has a bitter after taste and, when ingested, can produce undesirable side effects. Furthermore, ammonium chloride decomposes at cooking and baking temperatures thereby changing the pH value of the surrounding material affecting the taste and other properties of any cooked foods which contain it.

Accordingly, while progress has been made in this field, there remains a need in the art for low sodium salt substitute compositions which effectively mimic the flavor of salt. The present invention fulfills this need and provides further related advantages.

### BRIEF SUMMARY

In brief, the present disclosure is directed to low sodium salt substitute compositions, and food products comprising the same.

In one embodiment, a low sodium salt substitute composition is disclosed comprising: (i) from about 3% by weight to about 25% by weight of sodium acid sulfate;

(ii) from about 2% by weight to about 8% by weight of one or more umami ingredients; (iii) from about 0% by weight to about 50% by weight of potassium chloride; and (iv) from about 0% by weight to about 95% by weight of a filler.

In another embodiment, a food product (such as a low sodium soy sauce food product) comprising the low sodium salt substitute composition is disclosed.

In another embodiment, a low sodium soy sauce food product is disclosed comprising: (i) from about 1.5% by weight to about 2.5% by weight of sodium acid sulfate; (ii) from about 0.3% by weight to about 0.9% by weight of a 50/50 mixture of disodium inosinate and disodium guanylate; (iii) from about 7% by weight to about 8% by weight of a hydrolyzed soy protein; (iv) from about 0.01% by weight to about 0.05% by weight of one or more flavor masking or enhancing agents; (v) from about 3% by weight to about 4% by weight of potassium chloride; and (vi) from about 6.5% by weight to about 7.5% by weight of a maltodextrin.

In accordance with another aspect of the present disclosure, instead of potassium chloride, the composition includes from about 1% by weight to and including about 45% by weight of sodium chloride. Alternatively the composition can include sodium chloride in the range of either 5% by weight to and including about 35% by weight, or 15% by weight to and including about 30% by weight, or 18% by weight to and including about 25% by weight. In the alternative, the composition can include either 1% by weight to and including about 50% by weight sea salt or 25% by weight to and including about 50% by weight sea salt.

In accordance with another aspect of the present disclosure, the composition can include about 1% by weight to about 50% by weight of a blend of 43% sodium chloride and 57% potassium chloride, which are co-spray-dried.

In accordance with another aspect of the present disclosure, a low sodium salt substitute composition is provided that includes from about 3% by weight to about 25% by weight of sodium acid sulfate; from about 2% by weight to about 8% by weight of one or more umami ingredients; from about 0% by weight to about 50% by weight of sea salt; and from about 0% by weight to about 95% by weight of a filler.

These and other aspects of this disclosure will be evident upon reference to the following detailed description.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the following drawings, wherein:

FIG. 1 is a table of constituents for representative low sodium compositions formed in accordance with the present disclosure.

### DETAILED DESCRIPTION

In the following description, certain specific details are set forth in order to provide a thorough understanding of various embodiments of the present disclosure. However, one skilled in the art will understand that the disclosure may be practiced without one or more of these specific details. In other instances, well-known aspects of food products and methods of producing food products have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense to include alternatives and not in the conjunction “and” unless the context clearly dictates otherwise.

Values recited in this specification as a “range” are intended to include the end values noted therein. When values are described as “between” two end values, the end values in this case are not intended to be included.

As noted above, the present disclosure is directed to low sodium salt substitute compositions, and food products comprising the same.

In one embodiment, a low sodium salt substitute composition is disclosed comprising: (i) from about 3% by weight to about 25% by weight of sodium acid sulfate; (ii) from about 2% by weight to about 8% by weight of one or more umami ingredients; (iii) from about 0% by weight to about 50% by weight of potassium chloride; and (iv) from about 0% by weight to about 95% by weight of a filler.

In more specific embodiments, the composition may comprise from about 3% by weight to about 20% by weight of sodium acid sulfate, from about 12% by weight to about 20% by weight of sodium acid sulfate, from about 12% by weight to about 18% by weight of sodium acid sulfate, or from about 12% by weight to about 16% by weight of sodium acid sulfate.

In other more specific embodiments, the composition may comprise from about 2% by weight to about 6% by weight of one or more umami ingredients, or from about 3% by weight to about 5% by weight of one or more umami ingredients.

“Umami”, often referred to as the fifth taste, is used to describe flavors that are often thought of as pungent, savory, tangy or meaty. The taste is imparted by glutamate, a type of amino acid, and ribonucleotides, including inosinate and guanylate, which occur naturally in many foods including meat, fish, vegetables and dairy products. As used herein “umami ingredients” includes, but is not limited to, ingredients which impart the umami taste, such as monosodium glutamate, disodium inosinate, disodium guanylate, yeast extract (such as DSM Maxarome® Pure), hydrolyzed vegetable protein (such as Sensient Flavors CVP LS hydrolyzed soy protein), flavor masking or enhancing agents (such as Ungerer natural bitter masking agent FS 12059 and Ungerer natural salt enhancing agent FS 12061).

Accordingly, in other more specific embodiments, the one or more umami ingredients are selected from monosodium glutamate, disodium inosinate, disodium guanylate, yeast extract, hydrolyzed vegetable protein and flavor masking or enhancing agents.

In other more specific embodiments, the composition may comprise from about 20% by weight to about 30% by weight of potassium chloride.

In other more specific embodiments, the composition may comprise from about 45% by weight to about 95% by weight of a filler, from about 75% by weight to about 95% by weight of a filler, from about 30% by weight to about 80% by weight of a filler, from about 30% by weight to about 66% by weight of a filler, or about 0% by weight of a filler.

As used herein, “filler” refers to a bland or tasteless ingredient used to dilute or bulk a composition, such as a dextrin or maltodextrin. Accordingly, in other more specific embodiments, the filler is a dextrin or maltodextrin.

As one of skill in the art will appreciate, the presence of a filler in a low sodium salt substitute composition of the present disclosure is optional. Typically, if the low sodium salt substitute composition is intended for use as, for example, as table salt replacement, then a filler may be used to dilute or bulk the composition. However, if the low sodium salt substitute composition is incorporated into a food product during manufacturing, a filler is not necessary.

In another embodiment, a food product comprising any of the foregoing low sodium salt substitute compositions is disclosed. In more specific embodiments, the food product may be a low sodium soy sauce food product. In another embodiment, a low sodium soy sauce food product is disclosed comprising: (i) from about 1.5% by weight to about 2.5% by weight of sodium acid sulfate; (ii) from about 0.3% by weight to about 0.9% by weight of a 50/50 mixture of disodium inosinate and disodium guanylate; (iii) from about 7% by weight to about 8% by weight of a hydrolyzed soy protein; (iv) from about 0.01% by weight to about 0.05% by weight of one or more flavor masking or enhancing agents; (v) from about 3% by weight to about 4% by weight of potassium chloride; and (vi) from about 6.5% by weight to about 7.5% by weight of a maltodextrin.

In a more specific embodiment, the low sodium soy sauce food product comprises: (i) about 2.01% by weight of sodium acid sulfate; (ii) about 0.57% by weight of a 50/50 mixture of disodium inosinate and disodium guanylate; (iii) about 7.58% by weight of a hydrolyzed soy protein; (iv) about 0.01% by weight of a bitter masking agent; (v) about 0.03% by weight of a salt enhancing agent; (vi) about 3% by weight of potassium chloride; and (vii) about 6.9% by weight of a maltodextrin.

In other more specific embodiments, the low sodium soy sauce food product further comprises from about 4% by weight to about 5% by weight of sodium chloride.

It is understood that any embodiment of the compositions, as set forth above, may be independently combined with other embodiments of the compositions to form embodiments not specifically set forth above. In addition, in the event that a range of amounts is indicated for any particular ingredient in a particular embodiment, it is understood that all amounts falling within that range will be considered to be within the scope of the present disclosure. For example, the following various embodiments, are within the scope of the present disclosure:

1. A low sodium salt substitute composition comprising a minimum of about 3% by weight of sodium acid sulfate, about 2% by weight of one or more umami ingredients, no potassium chloride and a maximum of about 95% by weight of a filler.

2. A low sodium salt substitute composition comprising a maximum of about 20% by weight of sodium acid sulfate, about 5% by weight of one or more umami ingredients, no potassium chloride and a minimum of about 75% by weight of a filler.

3. A low sodium salt substitute composition comprising a minimum of about 3% by weight of sodium acid sulfate, about 2% by weight of one or more umami ingredients, a maximum of about 50% by weight of potassium chloride and a minimum of about 45% by weight of a filler.

4. A low sodium salt substitute composition comprising from about 12% by weight to about 25% by weight of sodium acid sulfate, from about 0% by weight to about 8% by weight of one or more umami ingredients, from about 0% by weight to about 50% by weight of potassium chloride and from about 30% by weight to about 80% by weight of a filler.

5. A low sodium salt substitute composition comprising from about 12% by weight to about 18% by weight of sodium acid sulfate, from about 2% by weight to about 6% by weight of one or more umami ingredients, from about 20% by weight to about 30% by weight of potassium chloride and from about 30% by weight to about 66% by weight of a filler.

6. A low sodium salt substitute composition comprising from about 14% by weight to about 16% by weight sodium acid sulfate, from about 3% by weight to about 5% by weight of one or more umami ingredients, from about 20% by weight to about 30% by weight of potassium chloride and from about 30% by weight to about 67% by weight of a filler.

As one of skill in the art will appreciate, the low sodium salt substitute compositions disclosed herein may used in a wide variety of food products, including, but not limited to: various types of noodles, such as macaroni and spaghetti; bread; snacks, such as potato chips; processed tomato-based foods, such as tomato juice and tomato puree; soups; various types of sauces and seasonings, such as soy sauce and barbeque sauce; pickled vegetables; various canned fish and dried fish; salt-preserved foods; various types of cheeses; meat products, such as bacon, ham and sausage; and dairy products, such as butter and margarine. Furthermore, as one of skill in the art will appreciate, the amount of low sodium salt substitute composition to be added is selected according to the purpose of use, and there is no particular limitation in this respect.

The following examples are provided for the purpose of illustration, not limitation. The compositions disclosed herein can be prepared by persons skilled in the art without an undue amount of experimentation using readily known techniques. For example, for use as a table salt substitute, the low sodium salt substitute composition should be dissolved in water and spray dried so that the blend becomes a uniform crystal.

### EXAMPLES

### Example 1

The following is a representative low sodium salt substitute composition of the present disclosure (all % are % by weight).

### Low Sodium Salt Substitute Composition 1

| | |
|---|---|
| Maltodextrin (10 DE) | 60.00% |
| Yeast extract (DSM Maxarome ® Pure) | 2.00% |
| Potassium chloride | 20.00% |
| Disodium inosinate & disodium guanylate (50/50) | 4.00% |
| Sodium acid sulfate | 14.00% |

### Example 2

The following is a representative low sodium salt substitute composition of the present disclosure (all % are % by weight).

### Low Sodium Salt Substitute Composition 2

| | |
|---|---|
| Maltodextrin (10 DE) | 57.00% |
| Yeast extract (DSM Maxarome ® Pure) | 2.00% |
| Potassium chloride | 25.00% |
| Disodium inosinate & disodium guanylate (50/50) | 4.00% |
| Sodium acid sulfate | 12.00% |

### Example 3

The following is a representative low sodium salt substitute composition of the present disclosure (all % are % by weight).

### Low Sodium Salt Substitute Composition 3

| | |
|---|---|
| Maltodextrin (10 DE) | 55.80% |
| Yeast extract (DSM Maxarome ® Pure) | 3.20% |
| Potassium chloride | 25.00% |
| Disodium inosinate & disodium guanylate (50/50) | 4.00% |
| Sodium acid sulfate | 12.00% |

### Example 4

The following is a representative low sodium salt substitute composition of the present disclosure (all % are % by weight).

### Low Sodium Salt Substitute Composition 4

| | |
|---|---|
| Maltodextrin (10 DE) | 55.00% |
| Yeast extract (DSM Maxarome ® Pure) | 2.00% |
| Potassium chloride | 25.00% |
| Disodium inosinate & disodium guanylate (50/50) | 4.00% |
| Sodium acid sulfate | 14.00% |

### Example 5

The following is a representative low sodium salt substitute composition of the present disclosure (all % are % by weight).

### Low Sodium Salt Substitute Composition 5

| | |
|---|---|
| Maltodextrin (10 DE) | 55.00% |
| Potassium chloride | 25.00% |
| Disodium inosinate & disodium guanylate (50/50) | 4.00% |
| Sodium acid sulfate | 16.00% |

### Example 6

The following is a representative low sodium salt substitute composition of the present disclosure (all % are % by weight).

Low Sodium Salt Substitute Composition 6

| | |
|---|---|
| Maltodextrin (10 DE) | 55.00% |
| Potassium chloride | 25.00% |
| Disodium inosinate & disodium guanylate (50/50) | 4.00% |
| Sodium acid sulfate | 16.00% |

### Example 7

The following is a representative low sodium salt substitute composition of the present disclosure (all % are % by weight).

### Low Sodium Salt Substitute Composition 7 (V-10a)

| | |
|---|---|
| Maltodextrin (10 DE) | 41.24967% |
| Potassium chloride | 18.75% |
| Disodium inosinate & disodium guanylate (50/50) | 3.00% |
| Sodium acid sulfate | 12.00% |
| Salt (sodium chloride) | 25.00% |
| Ungerer natural bitter masking agent (FS 12059) | 0.00025% |
| Ungerer natural salt enhancing agent (FS 12061) | 0.00008% |

### Example 8

The following is a representative low sodium salt substitute composition of the present disclosure (all % are % by weight).

### Low Sodium Salt Substitute Composition 8 (V-10)

| | |
|---|---|
| Maltodextrin (10 DE) | 41.25% |
| Potassium chloride | 18.75% |
| Disodium inosinate & disodium guanylate (50/50) | 3.00% |
| Sodium acid sulfate | 12.00% |
| Salt (sodium chloride) | 25.00% |

### Example 9

The following is a representative low sodium salt substitute composition of the present disclosure (all % are % by weight).

### Low Sodium Salt Substitute Composition 9 (V-5)

| | |
|---|---|
| Maltodextrin (10 DE) | 60.00% |
| Yeast extract (DSM Maxarome ® Pure) | 2.00% |
| Potassium chloride | 20.00% |
| Disodium inosinate & disodium guanylate (50/50) | 14.00% |

### Example 10

The following is a representative low sodium chicken soup food product comprising a representative low sodium salt substitute composition of the present disclosure (all % are % by weight).

| | |
|---|---|
| Chicken broth | 36.20% |
| Water | 36.20% |
| Chicken meat, cooked & diced | 13.39% |
| Pasta, cooked | 13.39% |
| Onion powder | 0.16% |
| White pepper, ground | 0.01% |
| Salt (sodium chloride) | 0.16% |
| Potassium chloride | 0.30% |
| Disodium inosinate & disodium guanylate (50/50) | 0.05% |
| Sodium acid sulfate | 0.10% |
| Ungerer natural bitter masking agent (FS 12059) | 0.03% |
| Ungerer natural salt enhancing agent (FS 12061) | 0.01% |

### Example 11

The following is a representative low sodium soy sauce food product comprising a representative low sodium salt substitute composition of the present disclosure (all % are % by weight).

| | |
|---|---|
| Molasses (Grandma's Unsulfured) | 1.57% |
| Tamarind concentrate (Seeni USA) | 0.76% |
| Hop extract (Kalsec CPF 045154) | 0.05% |
| Water | 68.14% |
| Malt extract (Malt Products # 102) | 5.06% |
| Hydrolyzed soy protein (Sensient CVP LS) | 7.58% |
| Maltodextrin (10 DE) | 6.90% |
| Potassium chloride | 3.14% |
| Disodium inosinate & disodium guanylate (50/50) | 0.57% |
| Sodium acid sulfate | 2.01% |
| Salt (sodium chloride) | 4.18% |
| Ungerer natural bitter masking agent (FS 12059) | 0.03% |
| Ungerer natural salt enhancing agent (FS 12061) | 0.01% |

Traditional soy sauce food products comprise high sodium chloride levels, which have a preservative effect on the composition by virtue of low water activity. The above low sodium soy sauce food product has a pH of about 3.46, which has a preservative effect on the composition when pasteurized at 180° F./82° C. for 2 minutes (in other words, the food product becomes shelf-stable). The above low sodium soy sauce food product has about 70% less sodium than commercially available Kikkoman soy sauce.

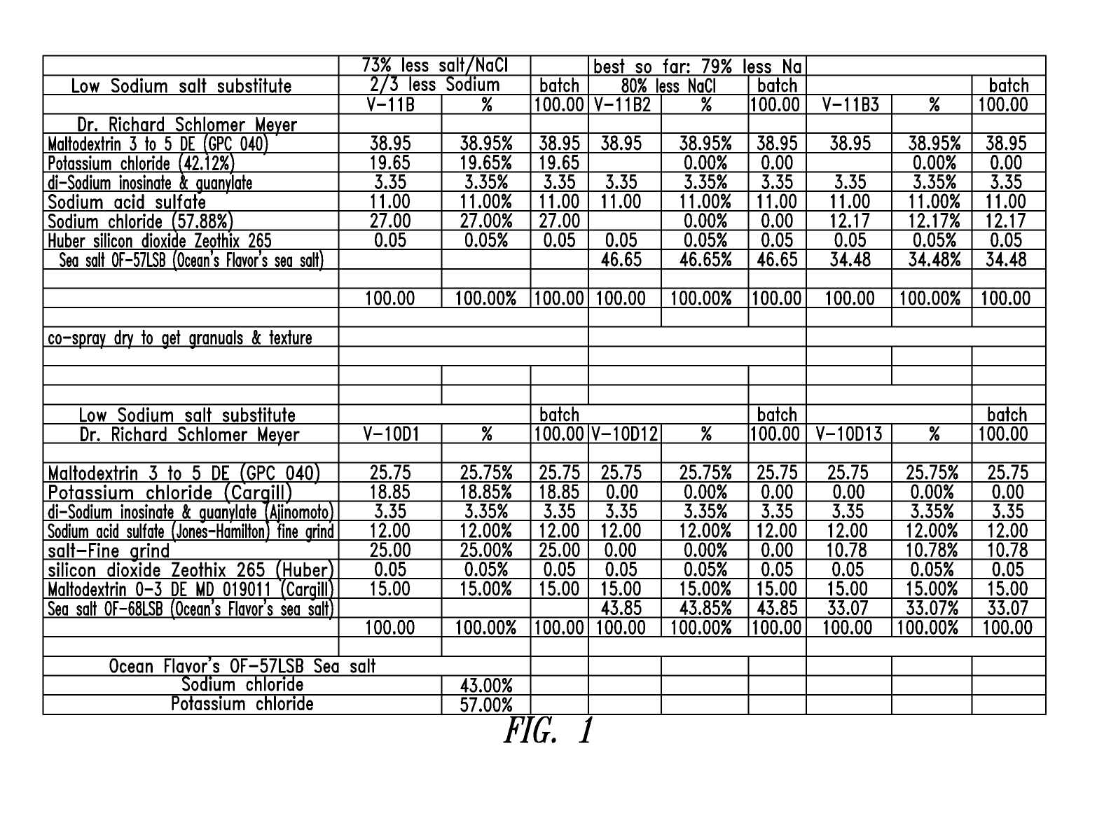

Referring next to FIG. 1, shown therein is a table of constituents for various representative low sodium compositions. In the first column is a listing of constituents for two exemplar low sodium salt substitute compositions. The top half of the column lists sodium chloride as a constituent, and in the bottom half of the first column fine grind salt is substituted for the sodium chloride. Different proportions of the constituents are shown across three broad columns that are identified as V11B, B11B2, and V11B3 for the composition in the top half of the first column in the table and identified as V-10D1, V-10D12, and V-10D13 for the composition listed in the bottom half of the first column. Hence, there are six representative compositions shown in the table of FIG. 1.

In the top half of the table of FIG. 1, example V-11B uses potassium chloride. In the remaining two compositions listed in the top half of the table of FIG. 1, the potassium chloride is replaced with sea salt of 46.65% by weight in example V-11B2 and 34.48% by weight in example V-11B3.

In the bottom half of the table of FIG. 1, example V-10D1 uses potassium chloride. In the remaining two compositions listed in the bottom half of the table, the potassium chloride is replaced with sea salt of 43.85% by weight in example V-10D2 and 33.07% by weight in example V-10D13.

Preferably, the sea salt is formed of 43.0% by weight sodium chloride and 57.0% by weight potassium chloride such as is found in Ocean Flavor's OF-57LSB sea salt. These amounts can vary so that the composition can include about 1% by weight to about 50% by weight of a blend of 43% sodium chloride and 57% potassium chloride, which are co-spray-dried.

It is to be understood that variations of the constituents can be made in each of the compositions. Thus, the composition can include in the range from about 1% by weight to about 45% by weight of sodium chloride. Alternatively the composition can include sodium chloride in the range of either about 5% by weight to about 35% by weight, or about 15% by weight to about 30% by weight, or about 18% by weight to about 25% by weight. In the alternative, the composition can include either about 1% by weight to about 50% by weight sea salt or about 25% by weight to about 50% by weight sea salt.

In accordance with another aspect of the present disclosure, a low sodium salt substitute composition is provided that includes from about 3% by weight to about 25% by weight of sodium acid sulfate; from about 2% by weight to about 8% by weight of one or more umami ingredients; from about 0% by weight to about 50% by weight of sea salt; and from about 0% by weight to about 95% by weight of a filler.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing, it will be appreciated that, although specific embodiments of the present invention have been described herein for purposes of illustration, various modifications may be made without deviating from the spirit and scope of the invention. Accordingly, the present invention is not limited except as by the appended claims.

1. A low sodium salt substitute composition comprising:
from about 3% by weight to about 25% by weight of sodium acid sulfate;
from about 2% by weight to about 8% by weight of one or more umami ingredients;
from about 0% by weight to about 50% by weight of potassium chloride; and
from about 0% by weight to about 95% by weight of a filler.

2. A composition of claim 1 comprising from about 3% by weight to about 20% by weight of sodium acid sulfate.

3. A composition of claim 1 comprising from about 12% by weight to about 20% by weight of sodium acid sulfate.

4. A composition of claim 1 comprising from about 12% by weight to about 18% by weight of sodium acid sulfate.

5. A composition of claim 1 comprising from about 12% by weight to about 16% by weight of sodium acid sulfate.

6. A composition of claim 1 comprising from about 2% by weight to about 6% by weight of one or more umami ingredients.

7. A composition of claim 1 comprising from about 3% by weight to about 5% by weight of one or more umami ingredients.

8. A composition of claim 1 wherein the one or more umami ingredients are selected from monosodium glutamate, disodium inosinate, disodium guanylate, yeast extract, hydrolyzed vegetable protein and flavor masking or enhancing agents.

9. A composition of claim 1 comprising from about 20% by weight to about 30% by weight of potassium chloride.

10. A composition of claim 1 comprising from about 45% by weight to about 95% by weight of a filler.

11. A composition of claim 1 comprising from about 75% by weight to about 95% by weight of a filler.

12. A composition of claim 1 comprising from about 30% by weight to about 80% by weight of a filler.

13. A composition of claim 1 comprising from about 30% by weight to about 66% by weight of a filler.

14. A composition of claim 1 comprising about 0% by weight of a filler.

15. A composition of claim 1 wherein the filler is a dextrin or maltodextrin.

16. A composition of claim 1 comprising from about 1% by weight to about 45% by weight of sodium chloride.

17. A composition of claim 1 comprising from about 5% by weight to about 35% by weight of sodium chloride.

18. A composition of claim 1 comprising from about 15% by weight to about 30% by weight of sodium chloride.

19. A composition of claim 1 comprising from about 18% by weight to about 25% by weight of sodium chloride.

20. A composition of claim 1 comprising from about 1% by weight to about 50% by weight of sea salt.

21. A composition of claim 1 comprising from about 25% by weight to about 50% by weight of sea salt.

22. A composition of claim 1 comprising from about 1% by weight to about 50% by weight of a blend 43% sodium chloride and 57% potassium chloride which are co-spray-dried.

23. A food product comprising a low sodium salt substitute composition, comprising:
from about 3% by weight to about 25% by weight of sodium acid sulfate;
from about 2% by weight to about 8% by weight of one or more umami ingredients;
from about 0% by weight to about 50% by weight of potassium chloride; and
from about 0% by weight to about 95% by weight of a filler.
